(19) United States
(12) Patent Application Publication
(10) Pub. No.: US 2025/0266561 A1
(43) Pub. Date: Aug. 21, 2025

(54) CONTAINER AND ENERGY STORAGE SYSTEM INCLUDING THE CONTAINER

(71) Applicant: SAMSUNG SDI CO., LTD., Yongin-si (KR)

(72) Inventor: Yu Sik HWANG, Suwon-si (KR)

(21) Appl. No.: 19/033,748

(22) Filed: Jan. 22, 2025

(30) Foreign Application Priority Data
Feb. 19, 2024 (KR) 10-2024-0023487

(51) Int. Cl. H01M 50/317; B65D 88/74

(52) U.S. Cl. CPC H01M 50/317; B65D 88/74

(57) ABSTRACT

A container and an energy storage system including the container is to provided such that the container is not damaged by gas collected in the container when an event such as a fire or explosion occurs in the container and such that the container can be reused by discharging the gas to outside of the container. The container includes a container body providing an internal space and an opening through which gas can be discharged out of the internal space to outside of the container, a hatch that is configured to close the opening and move in a direction to open the opening when the pressure in the internal space is greater than the pressure outside the container body, and a connecting part that connects the container body and the hatch.

### CROSS-REFERENCE TO RELATED APPLICATION

The present application claims priority to and the benefit of Korean Patent Application No. 10-2024-0023487, filed on Feb. 19, 2024, in the Korean Intellectual Property Office, the entire disclosure of which is incorporated herein by reference.

### BACKGROUND

### 1. Field of the Invention

The present disclosure relates to a container and an energy storage system including the container.

### 2. Discussion of Related Art

Generally, an energy storage system (ESS) is an apparatus that stores surplus electricity or electricity produced using new and renewable energy. The energy storage system may include a sealed container and a plurality of battery modules accommodated in the container.

When an event such as a fire occurs in a battery module in the container of an EES, the pressure of a gas due to flammable materials in the container increases, which may cause the container to be damaged so that the container cannot be reused.

The aforementioned information disclosed in this background section is merely for enhancement of understanding of the background technology of the present disclosure, and therefore may contain information that does not constitute the related art.

### SUMMARY OF THE INVENTION

The present disclosure is directed to providing a container that is not damaged by a gas collected in the container when an event, such as a fire or explosion, occurs in the container and can be reused by discharging gas to the outside of the container, and an energy storage system including the container.

These and other aspects and features of the present disclosure will be described in or will be apparent from the following description of some embodiments of the present disclosure.

According to an aspect of the present disclosure, there is provided a container including a container body providing an internal space and an opening through which gas can be discharged out of the internal space to outside of the container, a hatch that is configured to close the opening and move in a direction to open the opening when the pressure in the internal space is greater than a pressure outside the container body, and a connecting part that connects the container body and the hatch.

The connecting part may include a first connecting body supported by the container body, a second connecting body supported by the hatch, and a link part having a first side connected to the first connecting body and a second side connected to the second connecting body.

The link part may include a first link rod connected to the first connecting body, a second link rod connected to the second connecting body, and a hinge pin that connects the first link rod and the second link rod such that the first link rod and the second link rod are rotatable relative to each other.

The link part may further include a leaf spring that is interposed between the first link rod and the second link rod, with the hinge pin passing though the leaf spring.

The first connecting body may block the hatch to prevent the hatch from being inserted into the internal space of the container body through the opening.

The first connecting body may protrude from an inner side surface of the opening.

The connecting part may further include a third connecting body that connects the hatch and the second connecting body, and the second connecting body may be supported by the hatch through the third connecting body.

The connecting part may further include a buffer spring interposed between the hatch and the second connecting body.

The third connecting body may be fixed to the hatch, the third connecting body may include a guide part extending in one direction, the second connecting body may include an intervening part connected to the guide part, and as the intervening part moves in the one direction, a distance between the hatch and the second connecting body may change.

The container may further include a long hole formed in one of the first connecting body and the second connecting body, wherein the link part may include (i) a long hole coupling part fitted into the long hole and movable in a longitudinal direction of the long hole, and (ii) a link rod having a first side coupled to the other of the first connecting body and the second connecting body and a second side supporting the long hole coupling part.

The first side of the link rod may rotate with respect to the other of the first connecting body and second connecting body.

The one of the first connecting body and the second connecting body may include (i) a connecting body housing in which the long hole is formed and (ii) a pressing body that is accommodated in the connecting body housing and is in close contact with the long hole coupling part when the long hole coupling part moves in the longitudinal direction of the long hole.

The pressing body may include a plurality of grooves and the long hole coupling part may be configured to seat in the plurality of grooves, wherein, when the long hole coupling part seated in one groove among the plurality of the grooves moves in the longitudinal direction of the long hole, the long hole coupling part may move to another groove among the plurality of the grooves.

The long hole may extend in a direction intersecting the direction in which the hatch moves between a position at which the opening is opened and a position at which the opening is closed by the hatch, and the long hole may be formed in the second connecting body.

When the hatch moves in a direction opposite to a direction of gravity when closing the opening.

According to another aspect of the present disclosure, there is provided an energy storage system including a container including a container body providing an internal space and an opening through which gas can be discharged out of the internal space to outside of the container, a hatch that is configured to close the opening and move in a direction to open the opening when a pressure in the internal space is greater than a pressure outside the container body, and a connecting part that connects the container body and the hatch and one or more battery modules accommodated in the internal space.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings.

FIG. 1 is a perspective view illustrating an energy storage system according to one embodiment of the present disclosure;

FIG. 2 is a cross-sectional view along line II-II of FIG. 1, which illustrates a container according to a first embodiment of the present disclosure;

FIG. 3 is a cross-sectional view along line III-III of FIG. 2;

FIG. 4 is a cross-sectional view illustrating a hatch which moves to open an opening of a container body in the container of FIG. 2;

FIG. 5 is a cross-sectional view illustrating a container according to a second embodiment of the present disclosure;

FIG. 6 is a cross-sectional view illustrating a hatch which initially moves in a direction in which an opening of a container body is opened in the container of FIG. 5;

FIG. 7 is a cross-sectional view illustrating the hatch which moves to maximally open the opening of the container body in the container of FIG. 5;

FIG. 8 is a cross-sectional view along line VIII-VIII of FIG. 7;

FIG. 9 is a cross-sectional view illustrating a container according to a third embodiment of the present disclosure;

FIG. 10 is a cross-sectional view illustrating a hatch which moves to open an opening of a container body in the container of FIG. 9;

FIG. 11 is a cross-sectional view along line XI-XI of FIG. 10;

FIG. 12 is a cross-sectional view along line XII-XII of FIG. 11; and

FIG. 13 is a cross-sectional view illustrating a container according to a fourth embodiment of the present disclosure.

### DETAILED DESCRIPTION OF EXEMPLARY EMBODIMENTS

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

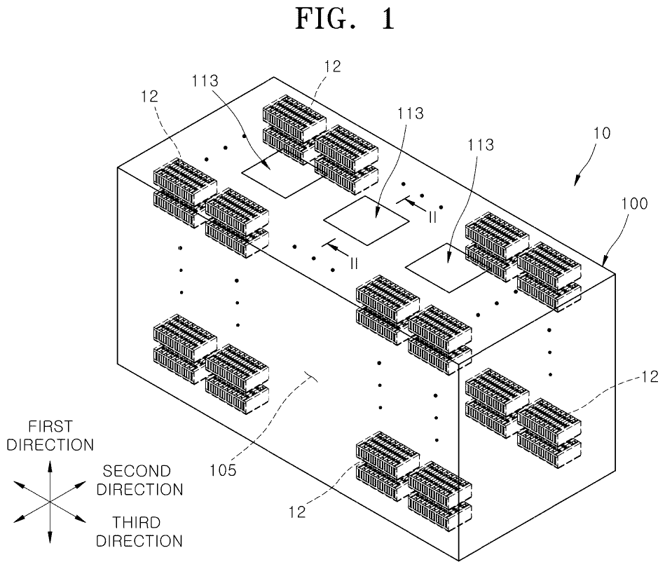

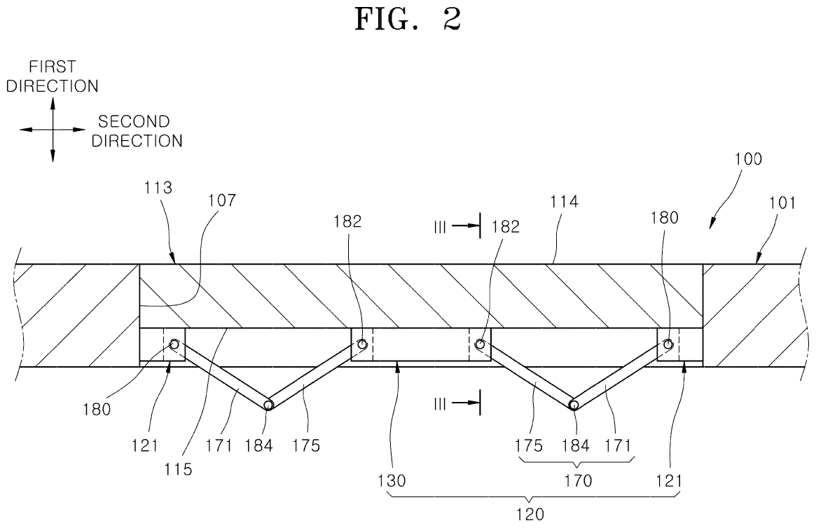

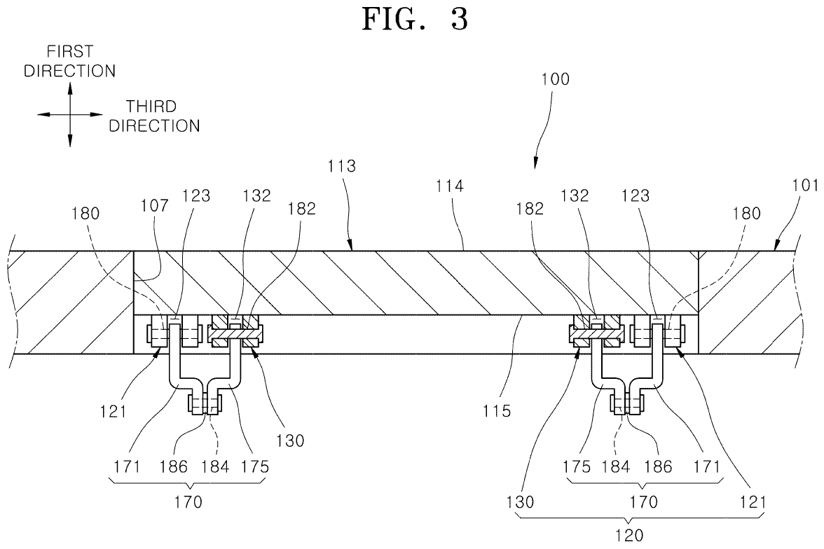

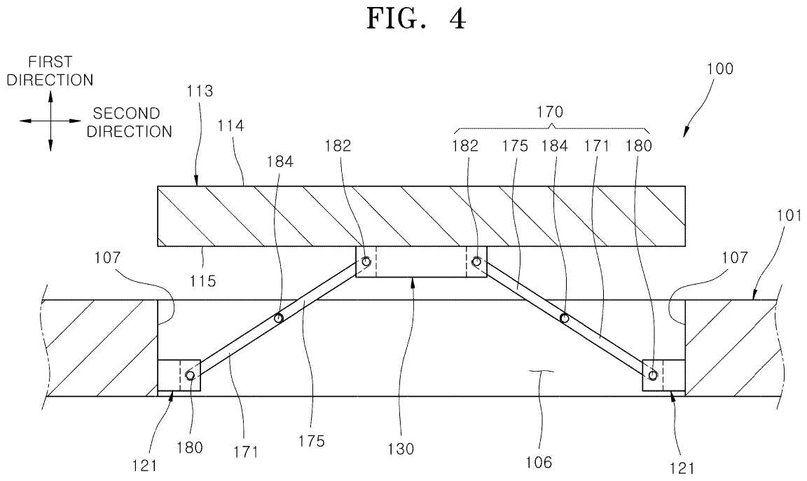

FIG. 1 is a perspective view illustrating an energy storage system according to one embodiment of the present disclosure, and FIG. 2 is a cross-sectional view along line II-II of FIG. 1, which illustrates a container according to a first embodiment of the present disclosure. FIG. 3 is a cross-sectional view along line III-III of FIG. 2, and FIG. 4 is a cross-sectional view illustrating a hatch that moves to open an opening of a container body in the container of FIG. 2.

Referring to FIGS. 1 to 4, an energy storage system 10 according to one embodiment of the present disclosure includes a container 100 and a plurality of battery modules 12. The container 100 includes a container body 101, a hatch 113, and a connecting part 120. An internal space 105 that accommodates a plurality of battery modules 12 is formed in the container body 101.

The container body 101 may be formed in a substantially rectangular parallelepiped shape and have six walls each having a rectangular plate shape. However, the shape of the container body 101 illustrated in FIG. 1 is only exemplary, and the container of the present disclosure may include a container body having a different shape.

The battery modules 12 are accommodated in the internal space 105 of the container body 101. Each of the battery modules 12 may include a module housing, a plurality of battery cells, and a battery management system (BMS) for managing a battery.

The battery cell may function as a unit structure that charges and discharges power in the energy storage system 10. Depending on the shape of the battery, a circular type battery cell, a prismatic type battery cell, or a pouch type battery cell may be used. The plurality of battery cells may be connected to each other in series or parallel.

One or more battery modules 12 may be provided. Hereinafter, although an example of the battery module 12 being provided as a plurality of battery modules 12 will be described, the battery module 12 is not limited thereto, and it is possible that the battery module 12 is provided in embodiments as a single battery module 12.

The plurality of battery modules 12 may be arranged in a three-dimensional matrix in the internal space 105 of the container body 101. For example, among the plurality of battery modules 12, one or more thereof may be arranged in a first direction, one or more thereof may be arranged in a second direction perpendicular to the first direction, and one or more thereof may be arranged in a third direction perpendicular to the first direction and the second direction. The first direction may be perpendicular to the second direction and the third direction, and the second direction may be perpendicular to the third direction and the first direction. For example, the first direction may be a height direction of the container body 101, the second direction may be a width direction of the container body 101, and the third direction may be a longitudinal direction of the container body 101.

The plurality of battery modules 12 may be accommodated in one or more rack frames (not shown) installed in the internal space 105 of the container body 101. The number of battery modules 12 accommodated in each rack frame may be designed in different ways according to a volume of the internal space 105 and the like.

One or more openings 106 through which a gas is discharged out of the internal space 105 to outside of the container 100 may be formed in the container body 101. For example, one or more openings 106 may be formed in a ceiling wall of the container body 101.

A hatch 113 may close each of the openings 106. When the pressure in the internal space 105 is greater than the pressure outside of the container body 101, the hatch 113 moves in a direction in which the opening 106 is opened. The hatch 113 may be, for example, a plate-like member having a uniform thickness. A planar shape of the hatch 113 may correspond to a planar shape of an inner side surface 107 that defines the opening 106 formed in the container body 101. The number of hatches 113 may correspond to the number of openings 106.

The connecting part 120 connects the container body 101 and the hatch 113. The connecting part 120 includes a first connecting body 121, a second connecting body 130, and a link part 170. The first connecting body 121 may be supported by the container body 101. The second connecting body 130 may be supported by the hatch 113. One side of the link part 170 may be coupled to the first connecting body 121, and the other side thereof may be coupled to the second connecting body 130.

The first connecting body 121 may protrude from the inner side surface 107 which defines the opening 106. For example, as illustrated in FIGS. 2 to 4, the first connecting body 121 may have a shape that protrudes from the inner side surface 107 and may be fixedly supported on the inner side surface 107. A plurality of first connecting bodies 121 may be provided. For example, when a planar shape of the inner side surface 107, which defines the opening 106, is quadrangular, four first connecting bodies 121 may be provided per one opening 106 so that one first connecting body 121 is disposed at each corner portion of the quadrangular inner side surface 107.

The second connecting body 130 may be fixedly supported on an inner surface 115 of the hatch 113. The inner surface 115 of the hatch 113 may be a side surface of the hatch 113 facing the internal space 105 of the container body 101, and an outer surface 114 of the hatch 113 may be a side surface opposite to the inner surface 115.

One second connecting body 130 may be provide between each pair of first connecting bodies 121. In the container 100 illustrated in FIGS. 2 to 4, one second connecting body 130 may be disposed between each pair of first connecting bodies 121 positioned at different coordinates in the second direction and positioned at the same coordinates in the third direction. Accordingly, one pair of second connecting bodies 130 may be provided per one opening 106.

Each of the second connecting bodies 130 may be disposed at an intermediate position between the pair of first connecting bodies 121 that are spaced apart from each other in the second direction. However, the positions and number of second connecting bodies 130 illustrated in FIGS. 2 to 4 are exemplary, and the container of the present disclosure may also include second connecting bodies in a number that corresponds one-to-one to the first connecting bodies.

The link part 170 connects the first connecting body 121 and the second connecting body 130. The number of link parts 170 may be the same as the number of first connecting bodies 121. Each of the link parts 170 may include a first link rod 171, a second link rod 175, a first link pin 180, a second link pin 182, a hinge pin 184, and a leaf spring 186.

One end of the first link rod 171 in a longitudinal direction may be connected to the first connecting body 121 by the first link pin 180. A gap 123 may be formed in the first connecting body 121, with one end of the first link rod 171 being rotatably fitted into the gap 123. A link pin through hole may also be formed in the first connecting body 121, with the first link pin 180 extending in the through hole. The link pin through hole through which the first link pin 180 passes may be formed in the one end of the first link rod 171.

In a state in which the one end of the first link rod 171 is fitted into the gap 123 of the first connecting body 121, as the first link pin 180 passes through and is fastened to the link pin through hole of the first connecting body 121 and the link pin through hole of the first link rod 171, the first link rod 171 is rotatably connected to the first connecting body 121.

One end of the second link rod 175 in a longitudinal direction may be connected to the second connecting body 130 by the second link pin 182. A gap 132 may be formed in the second connecting body 130, with one end of the second link rod 175 being rotatably fitted in the gap 132. A link pin through hole may also be formed in the second connecting body 130, with the second link pin 182 extending in the through hole. The link pin through hole through which the second link pin 182 passes may be formed in the one end of the second link rod 175.

In a state in which the one end of the second link rod 175 is fitted into the gap 132 of the second connecting body 130, as the second link pin 182 passes through and is fastened to the link pin through hole of the second connecting body 130 and the link pin through hole of the second link rod 175, the second link rod 175 is rotatably connected to the second connecting body 130.

The hinge pin 184 connects the other end of the first link rod 171 and the other end of the second link rod 175 to rotate relative to each other. A hinge pin through hole through which the hinge pin 184 passes may be formed in each of the other end of the first link rod 171 and the other end of the second link rod 175. As the hinge pin 184 passes through and is fastened to the hinge pin through hole of the first link rod 171 and the hinge pin through hole of the second link rod 175, the other end of the first link rod 171 and the other end of the second link rod 175 are connected to rotate relative to each other.

The leaf spring 186 may be interposed between the other end of the first link rod 171 and the other end of the second link rod 175. The hinge pin 184 may pass through the leaf spring 186. As the leaf spring 186 is in elastically close contact with the other end of the first link rod 171 and the other end of the second link rod 175. Thus, when the first link rod 171 and the second link rod 175 rotate relative to each other, frictional resistance may increase. Accordingly, a case in which the opening 106 is opened or closed due to a malfunction of the hatch 113 when an event such as a fire does not occur in the container body 101 can be suppressed.

One link part 170 may be connected to one side of the second connecting body 130 in the second direction, and the other link part 170 may be connected to the other side of the second connecting body 130 in the second direction.

The hatch 113 may be connected to the container body 101 by the connecting part 120 and moved between a first position at which the hatch 113 closes the opening 106 and a second position at which the hatch 113 opens the opening 106. The first connecting body 121 may block the hatch 113 to prevent the hatch 113 from being inserted into the internal space 105 of the container body 101 through the opening 106. For example, as illustrated in FIGS. 2 and 3, the hatch 113 may be supported by the plurality of first connecting bodies 121 at the first position at which the opening 106 is closed by the hatch 113.

When the hatch 113 is positioned at the first position, an event such as a fire in the battery module 12 accommodated in the internal space 105 may occur, causing a flaming material and a gas to accumulate in the internal space 105. Accordingly, when the pressure of the gas in the internal space 105 becomes greater than the pressure outside the container body 101, the hatch 113 may be moved to the second position such that the opening 106 is opened. As illustrated in FIG. 4, when the hatch 113 moves to the second position, an angle between the first link rod 171 and the second link rod 175 may become greater than when the hatch 113 is positioned at the first position.

When the hatch 113 is moved to the second position to open the opening 106, the gas and flaming material in the internal space 105 can be discharged to outside of the container body 101 through the opening 106, thereby causing the pressure in the internal space 105 to decrease. Thus, an increase in temperature is suppressed, and a major accident, such as an explosion of the container 100, can be prevented. In addition, since the container body 101, the hatch 113, and the connecting part 120 are not damaged, the container 100 can be reused, and thus the maintenance and operation costs of the energy storage system can be reduced.

In the embodiment of the container 100 illustrated in FIGS. 2 to 4, when the hatch 113 moves in a direction opposite to the direction of gravity from the first position at which the opening 106 is closed, the opening 106 may be opened. In FIGS. 2 to 4, it is illustrated that a direction in which the inner surface 115 of the hatch 113 faces is the direction of gravity and a direction in which the outer surface 114 of the hatch 113 faces is a direction opposite to the direction of gravity.

Since the temperature of the flaming material and gas generated due to a fire has a characteristic of rising above room temperature, when the hatch 113 moves in the direction opposite to the direction of gravity to open the opening 106, the flaming material and gas may be smoothly discharged to outside of the container body 101 through the opened opening 106. Accordingly, breakage and damage to the container 100 due to the internal fire can be prevented.

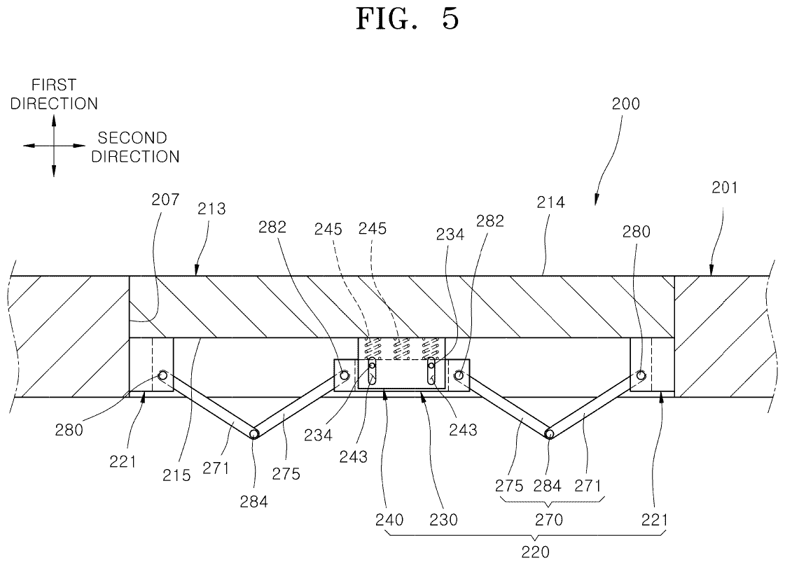

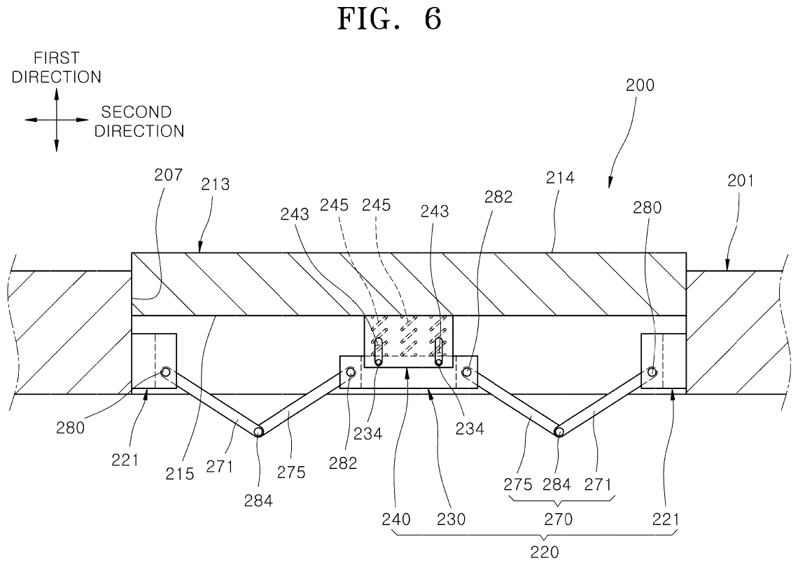

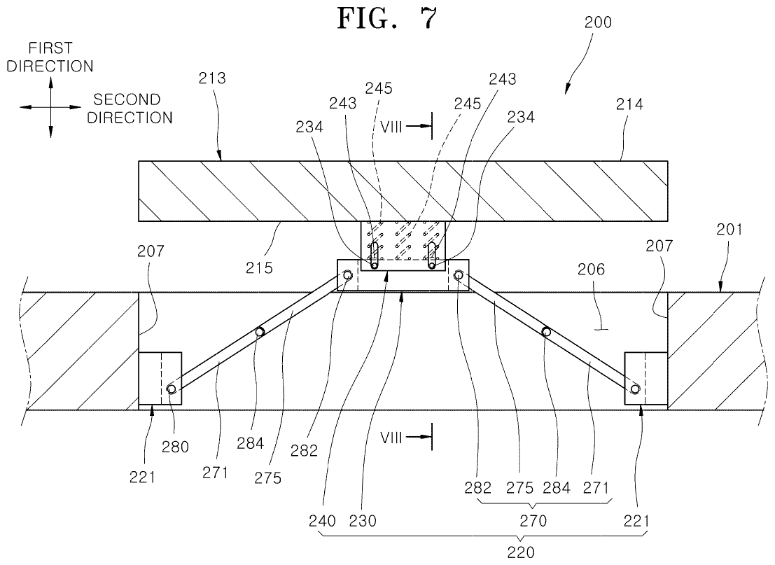

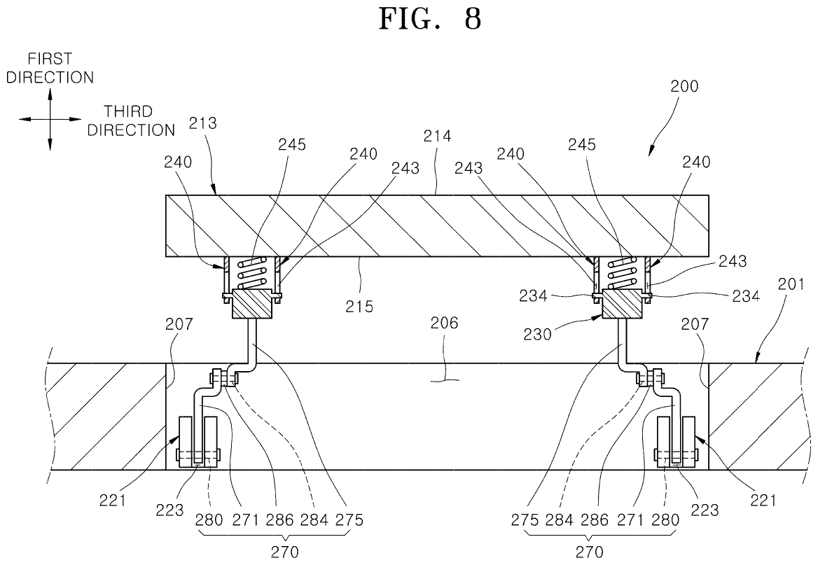

FIG. 5 is a cross-sectional view illustrating a container according to a second embodiment of the present disclosure, and FIG. 6 is a cross-sectional view illustrating a hatch which initially moves in a direction in which an opening of a container body is opened in the container of FIG. 5. FIG. 7 is a cross-sectional view illustrating the hatch which moves to maximally open the opening of the container body in the container of FIG. 5, and FIG. 8 is a cross-sectional view along line VIII-VIII of FIG. 7. Referring to FIGS. 1 and 5 to 8, a container 200 according to the second embodiment of the present disclosure may be provided in the energy storage system 10 of FIG. 1 as an alternative to the container 100 according to the first embodiment of the present disclosure illustrated in FIGS. 2 to 4.

The container 200 includes a container body 201, a hatch 213, and a connecting part 220. An internal space 105 that accommodates a plurality of battery modules 12 is formed in the container body 201.

An opening 206 through which a gas is discharged out of the internal space 105 to outside of the container 200 may be formed in the container body 201. For example, one or a plurality of openings 206 may be formed in a ceiling wall of the container body 201.

The hatch 213 closes the opening 206. When the pressure in the internal space 105 is greater than the pressure outside of the container body 201, the hatch 213 moves in a direction in which the opening 206 is opened. The hatch 213 may be, for example, a plate-like member having a uniform thickness. A planar shape of the hatch 213 may be a shape corresponding to a planar shape of an inner side surface 207 that defines the opening 206 formed in the container body 201. The number of hatches 213 may correspond to the number of openings 206.

The connecting part 220 connects the container body 201 and the hatch 213. The connecting part 220 includes a first connecting body 221, a second connecting body 230, a third connecting body 240, a buffer spring 245, and a link part 270.

The first connecting body 221 may be supported by the container body 201. The first connecting body 221 may protrude from the inner side surface 207 that defines the opening 206. For example, as illustrated in FIGS. 5 to 8, the first connecting body 221 may have a shape that protrudes from the inner side surface 207 and may be fixedly supported by the inner side surface 207. A plurality of first connecting bodies 221 may be provided. When a planar shape of the inner side surface 207, which defines the opening 206, is quadrangular, four first connecting bodies 221 may be provided per one opening 206 so that one first connecting body 221 is disposed at each corner portion of the quadrangular inner side surface 207.

The second connecting body 230 may be supported by the hatch 213. The third connecting body 240 connects the hatch 213 and the second connecting body 230. Accordingly, the second connecting body 230 is supported by the hatch 213 through the third connecting body 240.

The third connecting body 240 may be fixed to the hatch 213. For example, one end of the third connecting body 240 may be fixedly supported on an inner surface 215 of the hatch 213 in a first direction. The inner surface 215 of the hatch 213 may be a side surface of the hatch 213 facing the internal space 105 of the container body 201, and an outer surface 214 of the hatch 213 may be a side surface opposite to the inner surface 215.

The other end of the third connecting body 240 may overlap the second connecting body 230 in the first direction. The third connecting body 240 may include a pair of plate-like members spaced apart from each other in a third direction. The second connecting body 230 may be disposed between the pair of plate-like members.

The buffer spring 245 is interposed between the hatch 213 and the second connecting body 230. The buffer spring 245 may be disposed between the pair of plate-like members of the third connecting body 240. The buffer spring 245 may be, for example, a coil spring.

One end of the buffer spring 245 may be in fixed contact with hatch 213 in the first direction, and the other end of the buffer spring 245 in the first direction may be in fixed contact with the second connecting body 230. A plurality of buffer springs 245 may be provided and spaced apart from each other.

The third connecting body 240 may include a guide part 243 extending in one direction, and the second connecting body 230 may include an intervening part 234 connected to the guide part 243. As the intervening part 234 moves in a longitudinal direction of the guide part 243, a distance between the hatch 213 and the second connecting body may change.

The guide part 243 may include a long hole formed in the third connecting body 240, with the long hole extending in the first direction. The intervening part 234 may include a protrusion that protrudes from the second connecting body 230 and is fitted into the long hole of the guide part 243 to be moveable in a longitudinal direction of the long hole of the guide part 243.

One second connecting body 230 may be provided between each pair of first connecting bodies 221. For example, in the container 200 illustrated in FIGS. 5 to 8, one second connecting body 230 may be disposed between each pair of first connecting bodies 221, which are positioned at different coordinates in a second direction and positioned at the same coordinates in the third direction. Accordingly, one pair of second connecting bodies 230 may be provided per one opening 206.

Each of the second connecting bodies 230 may be disposed at an intermediate position between the pair of first connecting bodies 221 that are spaced apart from each other in the second direction. However, the positions and number of second connecting bodies 230 illustrated in FIGS. 5 to 8 are exemplary, and the container of the present disclosure may also include the second connecting bodies 230 in a number that corresponds one-to-one to the first connecting bodies 221.

The link part 270 connects the first connecting body 221 and the second connecting body 230. One end of the link part 270 may be coupled to the first connecting body 221, and the other end of the link part 270 may be coupled to the second connecting body 230. The number of link parts 270 may be the same as the number of first connecting bodies 221. Each of the link parts 270 may include a first link rod 271, a second link rod 275, a first link pin 280, a second link pin 282, a hinge pin 284, and a leaf spring 286.

One end of the first link rod 271 in a longitudinal direction may be connected to the first connecting body 221 by the first link pin 280. A gap 223 may be formed in the first connecting body 221, with one end of the first link rod 271 being rotatably fitted into the gap 223. A link pin through hole may be formed in the first connecting body 221, with the first link pin 280 extending in the through hole. The link pin through hole through which the first link pin 280 passes may be formed in the one end of the first link rod 271.

In a state in which the one end of the first link rod 271 is fitted into the gap 223 of the first connecting body 221, as the first link pin 280 passes through and is fastened to the link pin through hole of the first connecting body 221 and the link pin through hole of the first link rod 271, the first link rod 271 is rotatably connected to the first connecting body 221.

One end of the second link rod 275 in a longitudinal direction may be connected to the second connecting body 230 by the second link pin 282. A gap may be formed in the second connecting body 230, with one end of the second link rod 275 being rotatably fitted into the gap. A link pin through hole may also be formed in the second connecting body 230, with the second link pin 282 extending in the through hole. The link pin through hole through which the second link pin 282 passes may be formed in the one end of the second link rod 275.

In a state in which the one end of the second link rod 275 is fitted into the gap of the second connecting body 230, as the second link pin 282 passes through and is fastened to the link pin through hole of the second connecting body 230 and the link pin through hole of the second link rod 275, the second link rod 275 is rotatably connected to the second connecting body 230.

The hinge pin 284 connects the other end of the first link rod 271 and the other end of the second link rod 275 to rotate relative to each other. A hinge pin through hole through which the hinge pin 284 passes may be formed in each of the other end of the first link rod 271 and the other end of the second link rod 275. As the hinge pin 284 passes through and is fastened to the hinge pin through hole of the first link rod 271 and the hinge pin through hole of the second link rod 275, the other end of the first link rod 271 and the other end of the second link rod 275 are rotatable relative to each other.

The leaf spring 286 may be interposed between the other end of the first link rod 271 and the other end of the second link rod 275. The hinge pin 284 may pass through the leaf spring 286. As the leaf spring 286 is in elastically close contact with the other end of the first link rod 271 and the other end of the second link rod 275, when the first link rod 271 and the second link rod 275 rotate relative to each other, frictional resistance may increase. Thus, a case in which the opening 206 is opened or closed due to a malfunction of the hatch 213 when an event such as a fire does not occur in the container body 201 can be prevented.

One link part 270 may be connected to one side of the second connecting body 230 in the second direction, and the other link part 270 may be connected to the other side of the second connecting body 230 in the second direction.

The hatch 213 may be connected to the container body 201 by the connecting part 220 and moved between a first position at which the hatch 213 closes the opening 206 and a second position at which the hatch 213 opens the opening 206. The first connecting body 221 may block the hatch 213 to prevent the hatch 213 from being inserted into the internal space 105 of the container body 201 through the opening 206. For example, as illustrated in FIG. 5, the hatch 213 may be supported by the plurality of first connecting bodies 221 at the first position at which the opening 206 is closed. When the hatch 213 is positioned at the first position, a shape of the buffer spring 245 may be elastically compressed or may be a neutral shape that is not elastically expanded. When the buffer spring 245 has the neutral shape, the protrusion of the intervening part 234 may be positioned at one side in the long hole of the guide part 243 in the first direction. When the buffer spring 245 has the neutral shape, a distance between the hatch 213 and the second connecting body 230 may be a neutral distance.

When the hatch 213 is positioned at the first position, an event such as a fire in the battery module 12 accommodated in the internal space 105 may occur, causing a flaming material and a gas to accumulate in the internal space 105. When the pressure of the gas in the internal space 105 becomes greater than the pressure outside the container body 201, the hatch 213 is pushed by the pressure in the internal space 105 and moved in a direction opposite to a direction toward the internal space 105. As illustrated in FIG. 6, the link part 270 may not move and the buffer spring 245 may expand despite the hatch 213 moving to an intermediate position between the first position at which the opening 206 is closed and the second position at which the opening 206 is maximally opened. Accordingly, a distance between the hatch 213 and the second connecting body 230 may increase. In this case, the protrusion of the intervening part 234 may be positioned at the other side in the long hole of the guide part 243 in the first direction, and the distance between the hatch 213 and the second connecting body 230 may increase.

When the pressure in the internal space becomes greater due to the flaming material and gas, the hatch 213 may move from the intermediate position of FIG. 6 to the second position of FIGS. 7 and 8 to open the opening 206. When the hatch 213 moves to the second position, the third connecting body 240 fixed to the hatch 213 moves along with the hatch 213, the protrusion of the intervening part 234 is blocked by an end of the guide part 243 in the first direction, and the second connecting body 230 moves in the same direction as a movement direction of the third connecting body 240. As illustrated in FIG. 7, when the hatch 213 moves to the second position, an angle between the first link rod 271 and the second link rod 275 may become greater than when the hatch 213 is positioned at the first position.

When the opening 206 is opened, the gas and flaming material in the internal space 105 are discharged to outside of the container body 201 through the opening 206, causing the pressure of the internal space 105 to decrease. Thus, an increase in temperature is suppressed and a major accident, such as an explosion of the container 200, can be prevented. In addition, since the container body 201, the hatch 213, and the connecting part 220 are not damaged, the container 200 can be reused, and, thus, the maintenance and operation costs of the energy storage system can be reduced.

While the hatch 213 moves from the position shown in FIG. 5 to the position shown in FIG. 6, a shock applied to the hatch 213 is suppressed by a buffering action of the buffer spring 245. In addition, while the hatch 213 moves from the position shown in FIG. 5 to the position shown in FIG. 6, the link part 270 may not move. Accordingly, breakage or damage to the hatch 213, the second connecting body 230, and the link part 270 can be prevented.

In a state in which the hatch 213 is not supported on the first connecting body 221 and is spaced apart therefrom, when a shock is applied to the hatch 213 by an external force, since the buffer spring 245 elastically expands or contracts to absorb the shock, the shock is not transferred to the second connecting body 230 and link part 270. Thus, breakage and damage to the second connecting body 230 and the link part 270 can be prevented.

In the case of the container 200 illustrated in FIGS. 5 to 8, when the hatch 213 moves from the first position at which the opening 206 is closed in a direction opposite to the direction of gravity, the opening 206 may be opened. In FIGS. 5 to 8, it is illustrated that a direction in which the inner surface 215 of the hatch 213 faces is the direction of gravity and a direction in which the outer surface 214 of the hatch 213 faces is a direction opposite to the direction of gravity.

As the temperature of the flaming material and gas generated due to a fire have a characteristic of rising above room temperature, when the hatch 213 moves in the direction opposite to the direction of gravity to open the opening 206, the flaming material and gas may be smoothly discharged to outside of the container body 201 through the opened opening 206. Accordingly, breakage and damage to the container 200 due to the internal fire can be prevented.

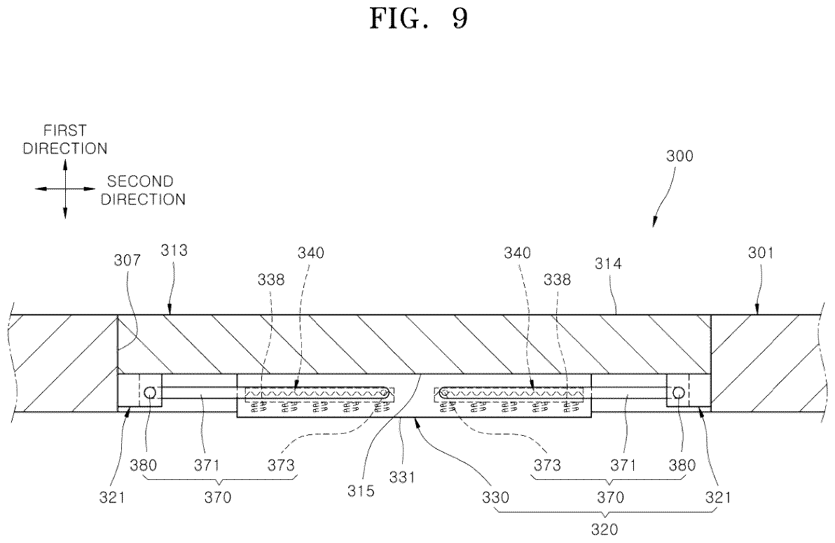

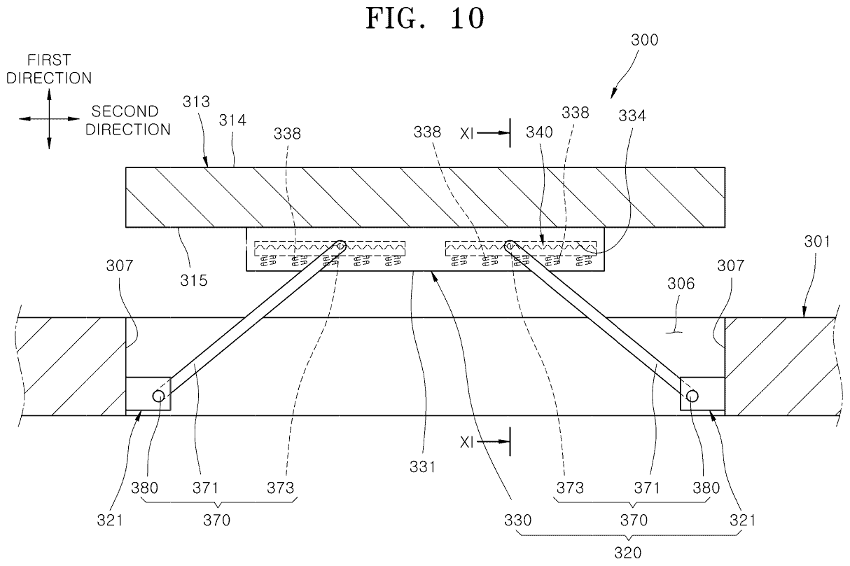

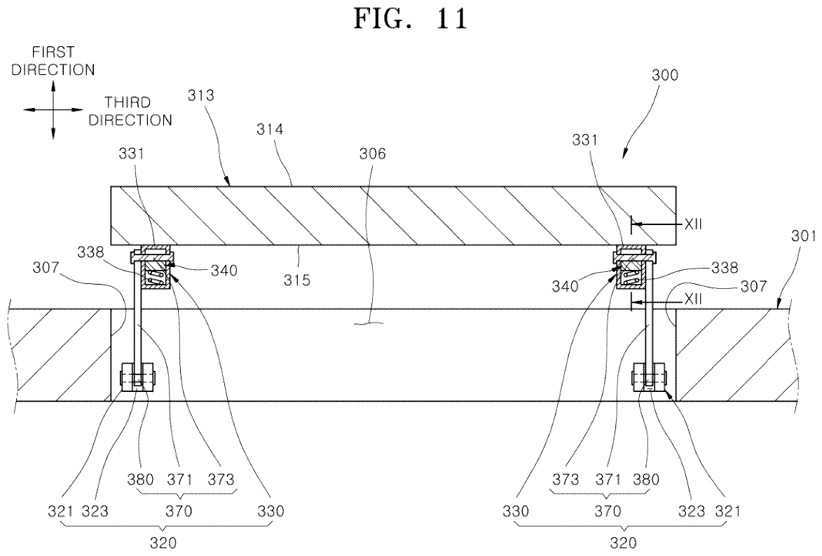

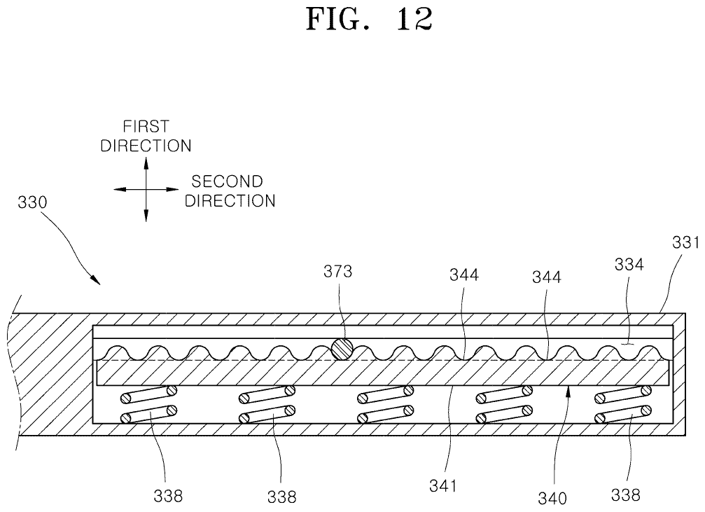

FIG. 9 is a cross-sectional view illustrating a container according to a third embodiment of the present disclosure, and FIG. 10 is a cross-sectional view illustrating a hatch which moves to open an opening of a container body in the container of FIG. 9. FIG. 11 is a cross-sectional view along line XI-XI of FIG. 10, and FIG. 12 is a cross-sectional view along line XII-XII of FIG. 11.

Referring to FIGS. 1 and 9 to 12, a container 300 according to the third embodiment of the present disclosure may be provided in the energy storage system 10 of FIG. 1 as an alternative to the container 100 according to the first embodiment of the present disclosure illustrated in FIGS. 2 to 4.

The container 300 includes a container body 301, a hatch 313, and a connecting part 320. An internal space 105 that accommodates a plurality of battery modules 12 is formed in the container body 301.

An opening 306 through which a gas can be discharged out of the internal space 105 to outside of the container 300 may be formed in the container body 301. For example, one or a plurality of openings 306 may be formed in a ceiling wall of the container body 301.

The hatch 313 closes the opening 306. When the pressure in the internal space 105 is greater than pressure outside the container body 301, the hatch 313 moves in a direction in which the opening 306 is opened. The hatch 313 may be, for example, a plate-like member having a uniform thickness. A planar shape of the hatch 313 may correspond to a planar shape of an inner side surface 307 that defines the opening 306 formed in the container body 301. The number of hatches 313 may correspond to the number of openings 306.

The connecting part 320 connects the container body 301 and the hatch 313. The connecting part 320 includes a first connecting body 321, a second connecting body 330, and a link part 370.

The first connecting body 321 may be supported by the container body 301. The first connecting body 321 may protrude from the inner side surface 307 that defines the opening 306. For example, as illustrated in FIGS. 9 to 11, the first connecting body 321 may have a shape that protrudes from the inner side surface 307 and may be fixedly supported on the inner side surface 307. A plurality of first connecting bodies 321 may be provided. For example, when a planar shape of the inner side surface 307, which defines the opening 306, is quadrangular, four first connecting bodies 321 may be provided per one opening 306 so that one first connecting body 321 is disposed at each corner portion of the quadrangular inner side surface 307.

The second connecting body 330 may be supported by the hatch 313. The second connecting body 330 may be fixedly supported on an inner surface 315 of the hatch 313. The inner surface 315 of the hatch 313 may be a side surface of the hatch 313 facing the internal space 305 of the container body 301, and an outer surface 314 of the hatch 313 may be a side surface opposite to the inner surface 315.

One second connecting body 330 may be provided between each pair of first connecting bodies 321. For example, in the container 300 illustrated in FIGS. 9 to 11, one second connecting body 330 is disposed between each pair of first connecting bodies 321 that are positioned at different coordinates in a second direction and positioned at the same coordinates in a third direction. Accordingly, one pair of second connecting bodies 330 may be provided per one opening 306.

Each of the second connecting bodies 330 may be disposed at an intermediate position between the pair of first connecting bodies 321 that are spaced apart from each other in the second direction. However, the positions and number of second connecting bodies 330 illustrated in FIGS. 9 to 11 are exemplary, and the container of the present disclosure may also include second connecting bodies in a number that corresponds one-to-one to the first connecting bodies.

The second connecting body 330 may include a connecting body housing 331. A long hole 334 may be formed in the connecting body housing 331. The long hole 334 may extend in a direction intersecting a direction in which the hatch 313 moves between a second position at which the opening 306 is opened and a first position at which the opening 306 is closed by the hatch 313. For example, if the direction in which the hatch 313 moves between the first position and the second position is a first direction, then the long hole 334 may extend in a second direction perpendicular to the first direction.

The connecting body housing 331 may extend in the second direction in which the long hole 334 extends. The connecting body housing 331 may be fixedly supported on the inner surface 315 of the hatch 313.

The link part 370 may include a link rod 371, a link pin 380, and a long hole coupling part 373. One end of the link rod 371 in a longitudinal direction may be connected to the first connecting body 321 by the link pin 380. A gap 323 may be formed in the first connecting body 321, with one end of the link rod 371 being rotatably fitted into the gap 323. A link pin through hole may also be formed in the first connecting body 321, with the link pin 380 extending in the through hole. The link pin through hole through which the link pin 380 passes may be formed in the one end of the link rod 371.

In a state in which the one end of the link rod 371 is fitted into the gap 323 of the first connecting body 321, as the link pin 380 passes through and is fastened to the link pin through hole of the first connecting body 321 and the link pin through hole of the link rod 371, the link rod 371 is rotatably connected to the first connecting body 321. The other end of the link rod 371 in the longitudinal direction may be connected to the second connecting body 330 by the long hole coupling part 373. The long hole coupling part 373 may be fitted into the long hole 334 and be movable in a longitudinal direction of the long hole 334. The long hole coupling part 373 may include a pin that protrudes from the other end of the link rod 371 to be fitted into the long hole 334 and has one side in a longitudinal direction coupled to the other end of the link rod 371.

The second connecting body 330 may further include a pressing body 340 and a spring 338. The pressing body 340 and the spring 338 are accommodated in the connecting body housing 331. The pressing body 340 may be elastically supported and be in close contact with the long hole coupling part 373 to increase frictional resistance when the long hole coupling part 373 moves in the longitudinal direction of the long hole 334.

With the configuration of the third embodiment, in a case in which the opening 306 is opened or closed due to a malfunction of the hatch 313 when an event such as a fire does not occur in the container body 301 can be prevented.

The pressing body 340 may extend in the same direction as the longitudinal direction of the long hole 334. A plurality of grooves 344 in which the long hole coupling part 373 may be seated are formed in one side surface of the pressing body 340 facing the long hole coupling part 373. The plurality of grooves 344 may be arranged in a row in the longitudinal direction of the long hole 334. A plurality of protruding protrusions may be formed in the pressing body 340 to separate pairs of adjacent grooves 344. Since the plurality of grooves 344 and the plurality of protrusions are alternately disposed, for example, as a wave pattern or sawtooth pattern formed on one side surface of the pressing body 340. In a state in which the long hole coupling part 373 is seated in one groove 344 among the plurality of grooves 344, when the hatch 313 moves, the long hole coupling part 373 may move in the longitudinal direction of the long hole 334. In this way, the long hole coupling part 373 moving in the longitudinal direction of the long hole 334 may be seated in grooves 344 among the plurality of grooves 344.

The spring 338 elastically presses the pressing body 340 in a direction such that the pressing body 340 is in close contact with the long hole coupling part 373. The spring 338 may be a coil spring. One side of the spring 338 may be in close contact with a spring support surface 341 opposite to one side surface of the pressing body 340 in which the plurality of grooves 344 are formed, and the other side of the spring 338 may be in close contact with the connecting body housing 331. A plurality of springs 338 may be provided, and the plurality of springs 338 may be spaced apart from each other in the longitudinal direction of the long hole 334.

One link part 370 may be connected to one side of the second connecting body 330 in the second direction, and a second link part 370 may be connected to the other side of the second connecting body 330 in the second direction. Accordingly, the long hole 334 into which the long hole coupling part 373 is fitted may be formed at each of one side and the other side of the connecting body housing 331 in the second direction. That is, two long holes 334 may be provided.

The hatch 313 may be connected to the container body 301 by the connecting part 320 and moved between the first position at which the opening 306 is closed by the hatch 313 and the second position at which the opening 306 is opened. The first connecting body 321 may block the hatch 313 to prevent the hatch 313 from being inserted into the internal space 105 of the container body 301 through the opening 306. For example, as illustrated in FIG. 9, the hatch 313 may be supported on the plurality of first connecting bodies 321 at the first position at which the opening 306 is closed.

When the hatch 313 is positioned at the first position, an event such as a fire in the battery module 12 accommodated in the internal space 105 may occur, causing a flaming material and a gas to accumulate in the internal space 105. Accordingly, when the pressure of the gas in the internal space 105 becomes greater than the pressure outside the container body 301, the hatch 313 may move to the second position at which the opening 306 is opened.

As illustrated in FIGS. 10 and 12, when the hatch 313 is pressed outward by the pressure in the internal space 105 of the container body 301, the long hole coupling part 373 moves in the long hole 334 toward an end of the long hole 334 in a longitudinal direction of the second connecting body 330 and is seated in another groove 344. Accordingly, the hatch 313 may move from the first position to the second position. When the hatch 313 moves from the first position to the second position, the link rod 371 may be inclined at a greater angle with respect to the second direction than when the hatch 313 is positioned at the first position.

When the hatch 313 moves to the second position to open the opening 306, the gas and flaming material in the internal space 105 can be discharged to outside of the container body 301 through the opening 306, causing the pressure of the internal space 105 to decrease. Thus, an increase in temperature is suppressed, and a major accident, such as an explosion of the container 300 may be prevented. In addition, since the container body 301, the hatch 313, and the connecting part 320 are not damaged, the container 300 can be reused, and, thus, the maintenance and operation costs of the energy storage system can be reduced.

In the case of the container 300 illustrated in FIGS. 9 to 11, when the hatch 313 moves from the first position at which the opening 306 is closed in a direction opposite to the direction of gravity, the opening 306 is opened. In FIGS. 9 to 11, it is illustrated that a direction in which the inner surface 315 of the hatch 313 faces is the direction of gravity and a direction in which the outer surface 314 of the hatch 313 faces is a direction opposite to the direction of gravity.

Since the temperature of the flaming material and gas generated due to a fire have a characteristic of rising above room temperature, when the hatch 313 moves in the direction opposite to the direction of gravity to open the opening 306, the flaming material and gas may be smoothly discharged toe outside of the container body 301 through the opened opening 306. Accordingly, breakage and damage to the container 300 due to the internal fire can be prevented more reliably.

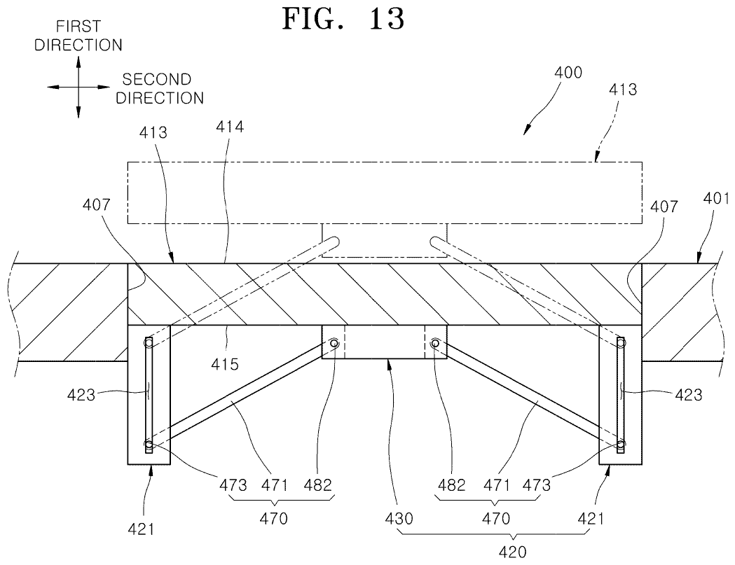

FIG. 13 is a cross-sectional view illustrating a container according to a fourth embodiment of the present disclosure. Referring to FIGS. 1 and 13, a container 400 according to the fourth embodiment of the present disclosure may be provided in the energy storage system 10 of FIG. 1 as an alternative to the container 100 according to the first embodiment of the present disclosure illustrated in FIGS. 2 to 4.

The container 400 includes a container body 401, a hatch 413, and a connecting part 420. An internal space 105 that accommodates a plurality of battery modules 12 is formed in the container body 401.

An opening through which a gas is discharged out of the internal space 105 to the outside of the container 400 may be formed in the container body 401. For example, one or a plurality of openings may be formed in a ceiling wall of the container body 401.

The hatch 413 closes the opening. When the pressure in the internal space 105 is greater than that the pressure outside the container body 401, the hatch 413 moves in a direction in which the opening is opened. The hatch 113 may be, for example, a plate-like member having a uniform thickness. A planar shape of the hatch 413 may correspond to a planar shape of an inner side surface 407 that defines the opening formed in the container body 401. The number of hatches 413 may correspond to the number of openings.

The connecting part 420 connects the container body 401 and the hatch 413. The connecting part 420 includes a first connecting body 421, a second connecting body 430, and a link part 470.

The first connecting body 421 may be supported by the container body 401. The first connecting body 421 may protrude from the inner side surface 407 that defines the opening. As illustrated in FIG. 13, the first connecting body 421 may have a shape that protrudes from the inner side surface 407 and may be fixedly supported on the inner side surface 407. A plurality of first connecting bodies 421 may be provided. For example, when a planar shape of the inner side surface 407, which defines the opening, is quadrangular, four first connecting bodies 421 may be provided per one opening so that one first connecting body 421 is disposed at each corner portion of the quadrangular inner side surface 407.

A long hole 423 may be formed in the first connecting body 421. The long hole 423 may have a uniform width and extend in the same direction as a direction that the hatch 413 moves between a second position at which the opening is opened and a first position at which the opening is closed. In FIG. 13, a state in which the hatch 413 is positioned at the first position is illustrated by solid lines, and a state in which the hatch 413 is positioned at the second position is illustrated by two-dot chain lines.

The direction in which the hatch 413 moves between the first position and the second position and a direction in which the long hole 423 extends may be a first direction. The first connecting body 421 may extend in the first direction in which the long hole 423 also extends.

The second connecting body 430 may be supported by the hatch 413. For example, the second connecting body 430 may be fixedly supported on an inner surface 415 of the hatch 413. The inner surface 415 of the hatch 413 may be a side surface of the hatch 413 facing the internal space 105 of the container body 401, and an outer surface 414 of the hatch 413 may be a side surface opposite to the inner surface 415.

One second connecting body 430 may be provided between each pair of first connecting bodies 421. For example, in the container 400 illustrated in FIG. 13, one second connecting body 430 is disposed between each pair of first connecting bodies 421 that are positioned at different coordinates in a second direction and positioned at the same coordinates in a third direction.

Each of the second connecting bodies 430 may be disposed at an intermediate position between the pair of first connecting bodies 421 that are spaced apart from each other in the second direction. However, the positions and number of second connecting bodies 430 illustrated in FIG. 13 are exemplary, and the container of the present disclosure may also include the second connecting bodies in a number that corresponds one-to-one to the first connecting bodies.

The link part 470 may include a link rod 471, a link pin 482, and a long hole coupling part 473. One end of the link rod 471 in a longitudinal direction may be connected to the first connecting body 421 by the long hole coupling part 473. The long hole coupling part 473 may be fitted into the long hole 423 to be moveable in a longitudinal direction of the long hole 423. The long hole coupling part 473 may include a pin that is fitted into the long hole 423 and has one side in a longitudinal direction coupled to the one end of the link rod 471. The other end of the link rod 471 in the longitudinal direction may be connected to the second connecting body 430 by the link pin 482. The other end of the link rod 471 may be rotatably connected to the second connecting body 430.

One link part 470 may be connected to one side of the second connecting body 430 in the second direction, and the other link part 470 may be connected to the other side of the second connecting body 430 in the second direction.

The hatch 413 may be connected to the container body 401 by the connecting part 420 and moved between the first position at which the opening is closed and the second position at which the opening is opened. The first connecting body 421 may block the hatch 413 to prevent the hatch 113 from being inserted into the internal space 105 of the container body 401 through the opening. For example, as illustrated by solid lines in FIG. 13, the hatch 413 may be supported on the plurality of first connecting bodies 421 at the first position at which the opening is closed by the hatch 413.

When the hatch 413 is positioned at the first position, an event such as a fire in the battery module 12 accommodated in the internal space 105 may occur, causing a flaming material and a gas to accumulate in the internal space 105. When the pressure of the gas in the internal space 105 becomes greater than the pressure outside the container body 401, the hatch 413 may move to the second position at which the opening is opened.

When the hatch 413 is positioned at the first position, the long hole coupling part 473 is positioned at one end of the long hole 423 in the longitudinal direction, and when the hatch 413 moves to the second position, the long hole coupling part 473 moves along with the hatch 413 in the longitudinal direction of the long hole 423 and is positioned at the other end of the long hole 423.

When the hatch 413 moves to the second position to open the opening, gas and flaming material in the internal space 105 may be discharged to outside of the container body 401 through the opening, causing the pressure of the internal space 105 to decrease. Thus, an increase in temperature is suppressed and a major accident such as an explosion of the container 200 can be prevented. In addition, since the container body 401, the hatch 413, and the connecting part 420 are not damaged, the container 4100 can be reused, and thus the maintenance and operation costs of the energy storage system can be reduced.

In the case of the container 400 illustrated in FIG. 13, when the hatch 413 moves from the first position at which the opening is closed in a direction opposite to the direction of gravity, the opening may be opened. In FIG. 13, it is illustrated that a direction in which the inner surface 415 of the hatch 413 faces is the direction of gravity and a direction in which the outer surface 414 of the hatch 413 faces is a direction opposite to the direction of gravity.

Since the temperature of the flaming material and gas generated due to a fire have a characteristic of rising above room temperature, when the hatch 413 moves in the direction opposite to the direction of gravity to open the opening, the flaming material and gas may be smoothly discharged to outside of the container body 401 through the opened opening. Accordingly, breakage and damage to the container 400 due to the internal fire can be prevented reliably.

According to an embodiment of the present disclosure, when a gas is collected in a container in which a battery module is accommodated due to an event such as a fire or explosion in the battery module, a hatch is moved apart from a container body by the pressure of the gas, an opening in the container body is opened, and, in this case, a connecting part that connects the hatch and the container body is not damaged. Accordingly, the container can be reused, and, thus, the maintenance and operation costs of an energy storage system can be reduced.

However, the effects that can be achieved through the present disclosure are not limited to the above-mentioned effects, and other technical effects that are not mentioned will be clearly understood by those skilled in the art from the description of the invention described below.

The present disclosure has been described with regard to a limited number of embodiments and drawings, but the present disclosure is not limited thereto and it is obvious to those skilled in the art that various modifications and changes may be made thereto within the technical spirit of the present disclosure and the equivalent scope of the appended claims.

What is claimed is:

1. A container comprising:
a container body providing an internal space and an opening through which gas can be discharged out of the internal space to outside of the container;
a hatch that is configured to close the opening and move in a direction to open the opening when a pressure in the internal space is greater than a pressure outside the container body; and
a connecting part that connects the container body and the hatch.

2. The container as recited in claim 1, wherein the connecting part includes:
a first connecting body supported by the container body;
a second connecting body supported by the hatch; and
a link part having a first side connected to the first connecting body and a second side connected to the second connecting body.

3. The container as recited in claim 2, wherein the link part includes:
a first link rod connected to the first connecting body;
a second link rod connected to the second connecting body; and
a hinge pin that connects the first link rod and the second link rod such that the first link rod and the second link rod are rotatable relative to each other.

4. The container as recited in claim 3, wherein the link part further includes a leaf spring that is interposed between the first link rod and the second link rod, with the hinge pin passing though the leaf spring.

5. The container as recited in claim 2, wherein the first connecting body blocks the hatch such that the hatch cannot be inserted into the internal space of the container body through the opening.

6. The container as recited in claim 5, wherein the first connecting body protrudes from an inner side surface of the opening.

7. The container as recited in claim 2, wherein the connecting part further includes a third connecting body that connects the hatch and the second connecting body, and
wherein the second connecting body is supported by the hatch through the third connecting body.

8. The container as recited in claim 7, wherein the connecting part further includes a buffer spring interposed between the hatch and the second connecting body.

9. The container as recited in claim 7, wherein the third connecting body is fixed to the hatch, the third connecting body includes a guide part extending in one direction, the second connecting body includes an intervening part connected to the guide part, and,
wherein, as the intervening part moves in the one direction, a distance between the hatch and the second connecting body changes.

10. The container as recited in claim 2, further comprising a long hole formed in one of the first connecting body and the second connecting body,
wherein the link part includes (i) a long hole coupling part fitted into the long hole and movable in a longitudinal direction of the long hole, and (ii) a link rod having a first side coupled to the other of the first connecting body and the second connecting body and a second side supporting the long hole coupling part.

11. The container as recited in claim 10, wherein the first side of the link rod rotates with respect to the other of the first connecting body and the second connecting body.

12. The container as recited in claim 10, wherein the one of the first connecting body and the second connecting body includes (i) a connecting body housing in which the long hole is formed; and
(ii) a pressing body that is accommodated in the connecting body housing and is in close contact with the long hole coupling part when the long hole coupling part moves in the longitudinal direction of the long hole.

13. The container as recited in claim 12, wherein the pressing body includes a plurality of grooves, and the long hole coupling part is configured to seat in the plurality of grooves, and
wherein, when the long hole coupling part seated in one groove among the plurality of the grooves moves in the longitudinal direction of the long hole, the long hole coupling part moves to another groove among the plurality of the grooves.

14. The container as recited in claim 10, wherein the long hole extends in a direction intersecting a direction in which the hatch moves between a position at which the opening is opened and a position at which the opening is closed by the hatch, and
wherein the long hole is formed in the second connecting body.

15. The container as recited in claim 1, wherein, when the hatch moves in a direction opposite to a direction of gravity when closing the opening.

16. An energy storage system comprising:
a container including:
a container body providing an internal space and an opening through which gas can be discharged out of the internal space to outside of the container,
a hatch that is configured to close the opening and move in a direction to open the opening when a pressure in the internal space is greater than a pressure outside the container body, and
a connecting part that connects the container body and the hatch; and
one or more battery modules accommodated in the internal space.
